(19) United States
(12) Patent Application Publication
(10) Pub. No.: US 2026/0004403 A1
(43) Pub. Date: Jan. 1, 2026

(54) SWIN TRANSFORMER-BASED WIRELESS CHANNEL ESTIMATION

(71) Applicant: Samsung Electronics Co., Ltd., Suwon-si (KR)

(72) Inventors: Xiaochuan Ma, Hillsborough, NJ (US); Yan Xin, Princeton, NJ (US); Daoud Burghal, San Jose, CA (US); Jianzhong Zhang, Dallas, TX (US)

(21) Appl. No.: 19/069,177

(22) Filed: Mar. 3, 2025

Related U.S. Application Data
(60) Provisional application No. 63/665,195, filed on Jun. 27, 2024.

(51) Int. Cl. G06T 5/60; G06V 10/72; G06V 10/77; G06V 10/774; H04L 27/26

(52) U.S. Cl. CPC G06T 5/60; G06V 10/72; G06V 10/7715; G06V 10/774; H04L 27/2651; G06T 2207/20021; G06T 2207/20081; G06T 2207/20084

(57) ABSTRACT

A base station (BS) includes a processor configured to generate training data for a shifted window (Swin) transformer-based channel estimation (CE) model, preprocess the training data, and train the Swin transformer-based CE model with the preprocessed training data. The BS also includes a transceiver operably coupled to the transceiver. The transceiver is configured to receive, over a wireless communication channel, a sounding reference signal (SRS). The processor is also configured to provide the SRS as an input image to the trained Swin transformer-based CE model, and receive as output from the trained Swin transformer-based CE model, a CE for the wireless communication channel.

### CROSS-REFERENCE TO RELATED APPLICATION(S) AND CLAIM OF PRIORITY

This application claims priority under 35 U.S.C. § 119(e) to U.S. Provisional Patent Application No. 63/665,195 filed on Jun. 27, 2024. The above-identified provisional patent application is hereby incorporated by reference in its entirety.

### TECHNICAL FIELD

This disclosure relates generally to wireless networks. More specifically, this disclosure relates to shifted window (Swin) transformer-based wireless channel estimation (CE).

### BACKGROUND

In wireless communication, channel estimation processes are utilized to provide reliable transmission of data between transmitters and receivers. Wireless communication systems are inherently susceptible to various impairments and variations in the radio propagation environment, leading to fluctuations in the channel characteristics. Channel estimation seeks to mitigate the adverse effects of these variations by providing accurate information about the current state of the communication channel.

### SUMMARY

This disclosure provides apparatuses and methods for Swin transformer-based wireless CE.

In one embodiment, a base station (BS) is provided. The BS includes a processor configured to generate training data for a shifted window (Swin) transformer-based channel estimation (CE) model, preprocess the training data, and train the Swin transformer-based CE model with the preprocessed training data. The BS also includes a transceiver operably coupled to the transceiver. The transceiver is configured to receive, over a wireless communication channel, a sounding reference signal (SRS). The processor is also configured to provide the SRS as an input image to the trained Swin transformer-based CE model, and receive as output from the trained Swin transformer-based CE model, a CE for the wireless communication channel.

In another embodiment, a method of operating a BS is provided. The method includes generating training data for a Swin transformer-based CE model, preprocessing the training data, and receiving, over a wireless communication channel, a SRS. The method also includes providing the SRS as an input image to the trained Swin transformer-based CE model, and receiving as output from the trained Swin transformer-based CE model, a CE for the wireless communication channel.

In yet another embodiment, a non-transitory computer readable medium embodying a computer program is provided. The computer program includes program code that, when executed by a processor of a device, causes the device to generate training data for a Swin transformer-based CE model, preprocess the training data, and train the Swin transformer-based CE model with the preprocessed training data. The computer program also includes program code that, when executed by the processor of a device, causes the device to receive, over a wireless communication channel, a SRS, provide the SRS as an input image to the trained Swin transformer-based CE model, and receive as output from the trained Swin transformer-based CE model, a CE for the wireless communication channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present

disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for Swin transformer-based channel estimation according to embodiments of the present disclosure;

FIG. 5 illustrates an example method for preprocessing channel data according to embodiments of the present disclosure;

FIG. 6 illustrates an example architecture of a Swin transformer-based channel estimation model according to embodiments of the present disclosure;

FIG. 7 illustrates an example Swin transformer layer (STL) structure according to embodiments of the present disclosure;

FIG. 8 illustrates an example of shifted window partitioning according to embodiments of the present disclosure;

FIG. 9 illustrates an example limitation of square attention windows according to embodiments of the present disclosure; and

FIG. 10 illustrates an example method for Swin transformer-based wireless CE according to embodiments of the present disclosure.

### DETAILED DESCRIPTION

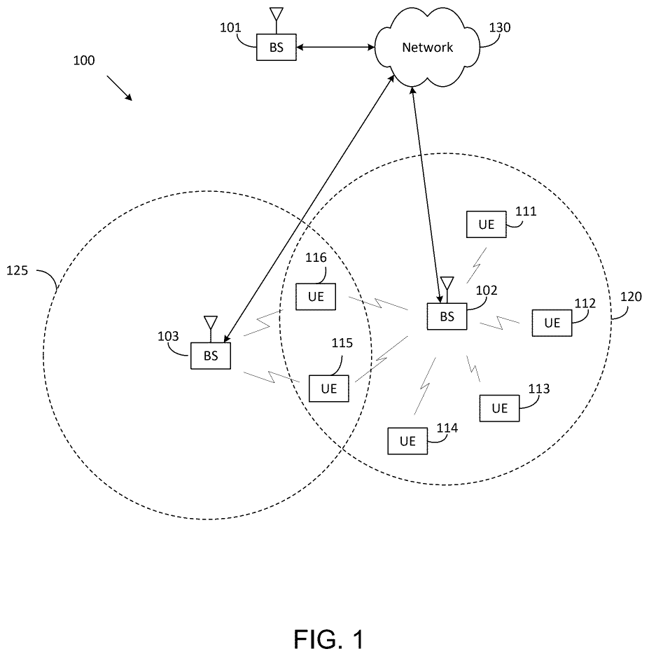

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band.

For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for Swin transformer-based wireless CE. In certain embodiments, one or more of the gNBs 101-103 includes circuitry, programing, or a combination thereof, to support Swin transformer-based wireless CE in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

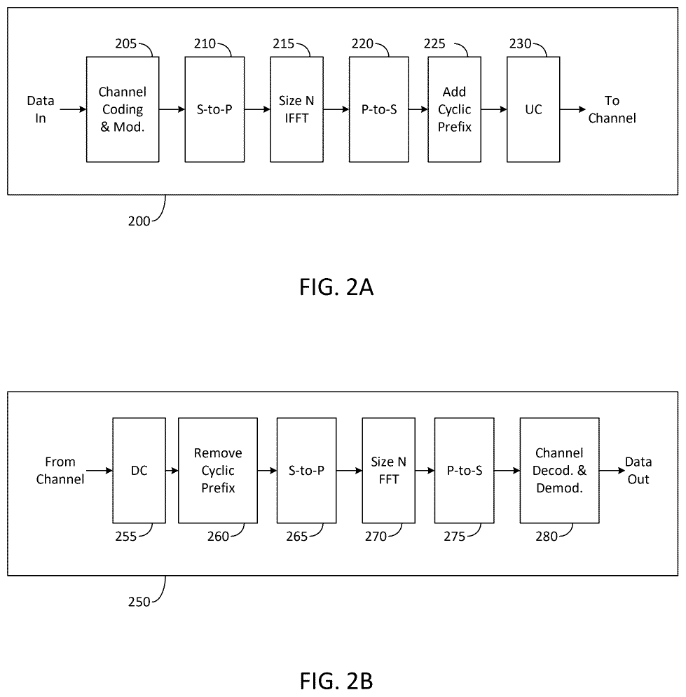

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support Swin transformer-based wireless CE as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols.

The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

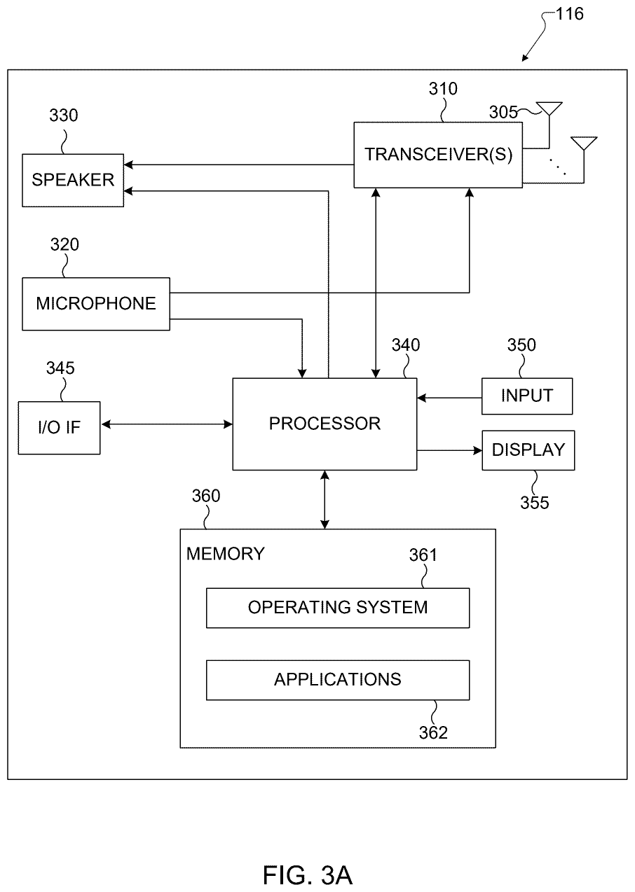

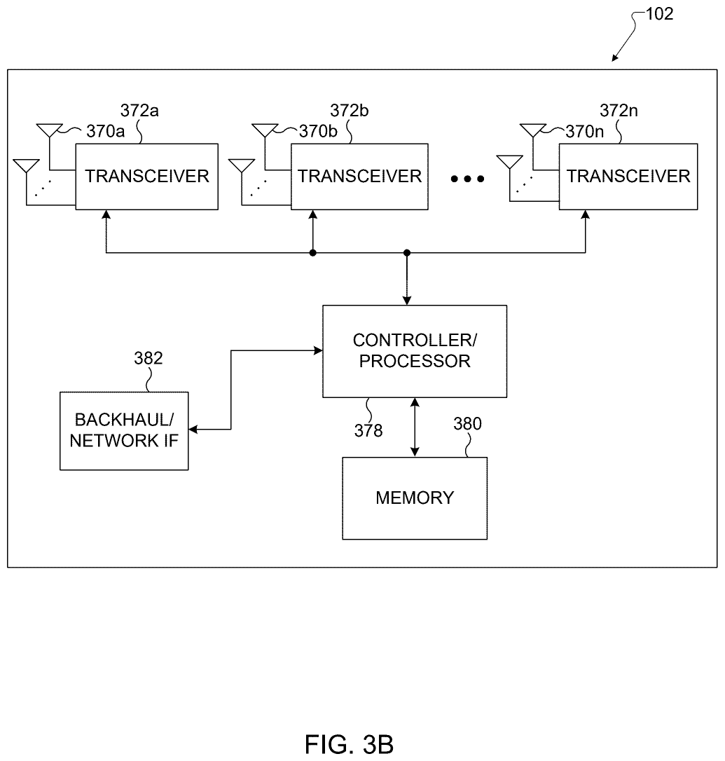

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for Swin transformer-based wireless CE as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support Swin transformer-based wireless CE as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

A wireless channel is a dynamic medium through which signals are transmitted. Wireless channels can be affected by factors such as multi-path fading, interference, noise, and mobility. Channel estimation serves as a mechanism to track and adapt to these dynamic changes, allowing the communication system to optimize its performance. Channel estimation is a process of estimating the characteristics of a wireless communication channel, such as its frequency response, delay spread, and fading coefficients, which are used by the receiver to demodulate and decode transmitted signals accurately. Channel estimation is important for coherent detection and decoding of transmitted signals, as well as for optimization of transmission parameters, such as power allocation, modulation scheme, and coding rate. Channel estimation can improve the accuracy and reliability of received signals, as well as increase the capacity and performance of wireless communication systems.

Various methods for channel estimation often utilize pilot signals, which are known symbols inserted into the transmitted signal, allowing the receiver to measure the channel response at specific points in time. These measurements are then used to interpolate the channel characteristics between pilot symbols, thus providing an estimate of the channel conditions. Various methods and techniques have been proposed to tackle this problem, such as linear interpolation, least squares, minimum mean square error, maximum likelihood, Bayesian interference, and deep learning.

However, channel estimation is also challenging, especially for high-dimensional signals that involve multiple antennas, multiple subcarriers and multiple users. The channel estimation problem can be formulated as finding the optimal solution of a system of equations that relate the transmitted and received signals with the channel coefficients and the noise. The complexity and difficulty of this problem depends on the number and arrangement of the channel coefficients, the availability and quality of the pilot signals, the noise level and distribution, and the channel dynamics and variations. Some channel estimation solutions such as least square (LS) and linear minimum mean square error (LMMSE) fail to achieve desirable estimation accuracy with reasonable complexity, particularly in the low signal-to-noise ratio (SNR) regime.

Recently, the integration of machine learning techniques into channel estimation processes has gained substantial attention and shown great promise in improving the accuracy and efficiency of channel estimation. Machine learning-based channel estimation leverages the power of artificial intelligence and data-driven approaches to adapt and learn from the wireless channel's behavior, making channel estimation more robust to varying conditions and potentially reducing the need for explicit pilot signals.

Some common machine learning-based channel estimation methods include deep learning approaches, reinforcement learning, autoencoders, transfer learning, and diffusion models.

Deep learning approaches utilizing deep neural networks (DNNs) (including convolutional neural networks [CNNs] and recurrent neural networks [RNNs]) have been applied to channel estimation tasks. These networks can learn complex relationships between received signals and the channel characteristics, allowing for accurate and efficient estimation.

Reinforcement learning techniques can be used to optimize the transmission and reception strategies in response to changing channel conditions, effectively improving channel estimation and overall system performance.

Autoencoders are neural network architectures that can be used for unsupervised learning of channel representations. Autoencoders can capture channel characteristics and reduce the reliance on pilot signals.

Transfer learning techniques enable the adaptation of pre-trained models to specific channel environments, enhancing the generalization of channel estimation algorithms across different scenarios.

Diffusion models include denoising diffusion probabilistic models (DDPM) and score matching with Langevin dynamics (SMLD). Based on the SMLD algorithm, some channel estimation solutions first learn a score function of the channel data using denoising score matching, obtain a close-form score function of the likelihood, and finally complete a posterior sampling process following annealed Langevin dynamics.

Machine learning-based channel estimation methods hold the potential to make wireless communication systems more adaptive, efficient, and robust, particularly in challenging environments. As the field of machine learning continues to advance, these methods are expected to play an increasingly important role in optimizing wireless communication systems for a wide range of applications, including 5G, IoT, and beyond. Shifted window (Swin) transformer approaches have shown great promise in machine learning-based channel estimation, as Swin transformer approaches integrate the advantages of both CNN and Transformer based approaches. Swin transformer approaches have the advantage of CNN based approaches to process images of large size due to the local attention mechanism. Swin transformer approaches also have the advantage of Transformer based approaches to model long-range dependency with the shifted window scheme.

Various embodiments of the present disclosure apply a Swin transformer-based image restoration algorithm to the channel estimation task.

In the present disclosure, the channel estimation problem may be solved as follows: In the frequency domain, the input-output relationship at pilot tones (subcarriers) between transmitted and received signals can be expressed as

$$Y = H ⊙ X + N , \qquad ( 1 )$$

where Y∈ [symbol] ^{N}^{_{fp}}^{×N}^{_{fn}} are the received signals at pilot tones, H∈ [symbol] ^{N}^{_{fp}}^{×N}^{_{fn}} is the channel matrix, ⊚ represents the Hadamard product that is an element-wise product, X∈ [symbol] ^{N}^{_{fp}}^{×N}^{_{fn}} are the transmitted pilot signals known to the receiver, and N∈ [symbol] ^{N}^{_{fp}}^{×N}^{_{fn}} is an additive white Gaussian noise (AWGN).

In particular, the mathematical model described in equation (1) is applicable to different types of signal models (including but not limited to single-input single-output [SISO], single-input multiple-output [SIMO], multiple-input multiple-output [MIMO] cases etc.). For example, in a SIMO signal model, N_{fp} and N_{fn} can be used to represent the number of the pilot tones (subcarriers) in the frequency domain over one OFDM symbol and the number of the receive antennas, respectively. On the other hand, in a SISO case, N_{fp} and N_{fn} can be used to represent the number of the pilot tones (subcarriers) in the frequency domain over one OFDM symbol and the number of the OFDM symbols containing pilot tones, respectively. Note that MIMO signal models can be readily converted to a SIMO case where pilot signals from different transmitted antennas are separated in time, frequency, or code domains.

The goal of the channel estimation task is to estimate the channel matrix H based on pilot signals X and received signals Y. Without loss of generality, the present disclosure assumes pilot signals X to be an identity matrix, and thus the signal model in equation (1) can be rewritten as

$$\tilde{H} = H + N . \qquad ( 2 )$$

Note that the various embodiments of the present disclosure can be readily applied to the case where pilot signals X are not an identity matrix.

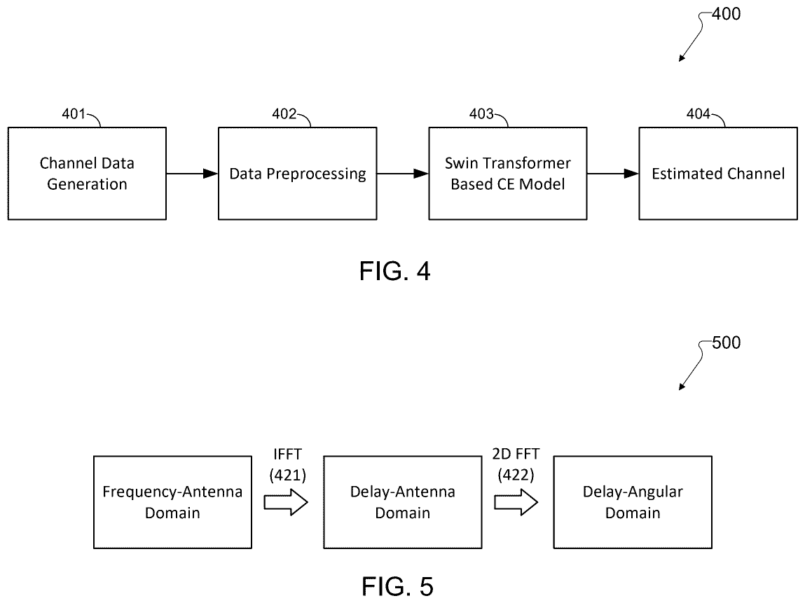

FIG. 4 illustrates an example procedure 400 for Swin transformer-based channel estimation according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for Swin transformer-based channel estimation could be used without departing from the scope of this disclosure.

In the example of FIG. 4, the procedure 400 for Swin transformer-based channel estimation includes four steps. In some embodiments, the four steps of procedure 400 may be performed by a network entity. For example, procedure 400 may be performed by a BS (such as gNB 102 of FIG. 1). However, it should be understood that in some embodiments, each step of procedure 400 can be performed by different apparatuses, such as other network entities, simulators, user equipment, etc.

Procedure 400 begins at step 401. At step 401, wireless channel data is generated to be used for model training and testing of a Swin transformer-based CE model. As described herein, channel data generation refers to a process to obtain channel response data or received signal data. During the channel data generation process, additional information about the channel or received signals, e.g., signal to noise ratio (SNR) or transmission power, should also be estimated and stored. In some embodiments, the channel data may be generated based on a simulated channel. For example, channel data generation may be performed by channel simulation based on wireless channel models. In some embodiments, channel data generation may be performed in the field. For example, the channel data may be generated by a UE (such as UE 116 of FIG. 1) being served by a network entity (such as gNB 102 of FIG. 1).

The input and output of the Swin transformer-based CE model are images representing the noisy channel response and the true channel response, respectively. The channel response matrix can be represented as H∈ [symbol] ^{N}^{_{fp}}^{×N}^{_{fn}}. In a SIMO signal model, N_{fp} and N_{fn} can be used to represent the number of the pilot tones (subcarriers) in the frequency domain over one OFDM symbol and the number of the received antennas, respectively.

By transforming the channel response to other domains, such as a delay-antenna domain or a delay-angular domain, the channel data could become sparser. Increased sparsity of data can bring some benefits to the Swin transformer-based CE model, such as:
Regularization effect: Sparse data acts as a natural form of regularization. When the available data is limited, models tend to generalize better because they focus on essential patterns rather than memorizing noise.
Feature importance: Sparse data highlights the importance of features. Rare but informative features receive more attention from the model.
Efficient storage and processing: Sparse representations require less memory and computational resources, making sparse representations efficient for large-scale applications.

At step 402, the channel data generated at step 401 is preprocessed so that the channel data has a sparser structure. In some embodiments, the channel data may be preprocessed as shown in FIG. 5.

FIG. 5 illustrates an example method 500 for preprocessing channel data according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a method for preprocessing channel data could be used without departing from the scope of this disclosure.

In the example of FIG. 5, method 500 begins at step 421. At step 421, the channel data generated at step 401 is transformed from the frequency-antenna domain to a delay-antenna domain using an Inverse Fast Fourier Transform (IFFT).

At step 422, the data transformed at step 421 is transformed from the delay-antenna domain to a delay-angular domain using a 2-dimensional Fast Fourier Transform (2D FFT) based on the structure of the antenna. The channel response on the transformed domain can then be used as the input and output of the Swin transformer-based CE model.

Although FIG. 5 illustrates one example method 500 for preprocessing channel data, various changes may be made to FIG. 5. For example, while shown as a series of steps, various steps in FIG. 5 could overlap, occur in parallel, occur in a different order, occur any number of times, be omitted, or replaced by other steps.

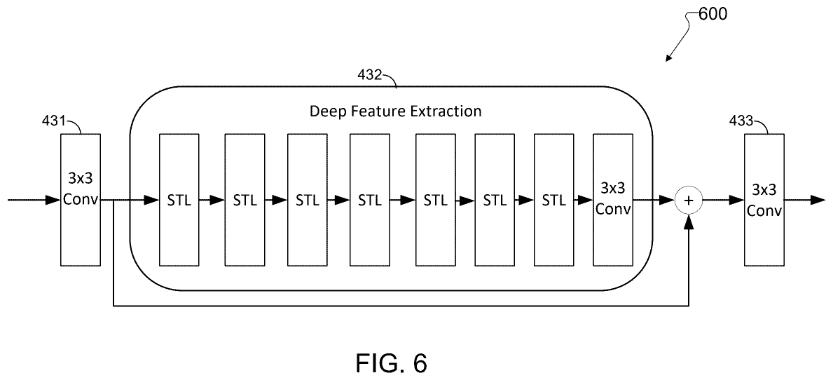

At step 403, the Swin transformer-based CE model is trained with the preprocessed data set (images) resulting from the preprocessing of the channel data at step 402. The Swin transformer-based CE model takes a noisy channel response image as input and outputs an estimated channel response image. In some embodiments, in correspondence with the data preprocessing at step 402, the estimation result (i.e., the output of the Swin transformer-based CE model) may be converted back to the frequency-antenna domain. In some embodiments, the architecture of the Swin transformer-based CE model may be as shown in FIG. 6.

FIG. 6 illustrates an example architecture 600 of a Swin transformer-based channel estimation model according to embodiments of the present disclosure. The embodiment of an architecture of a Swin transformer-based CE model of FIG. 6 is for illustration only. Different embodiments of an architecture of a Swin transformer-based CE could be used without departing from the scope of this disclosure.

In the example of FIG. 6, architecture 600 includes three components:
Shallow Feature Extraction (431): This initial step extracts low-level features from the input noisy channel response image. In the example of FIG. 6, a 3×3 convolutional layer is used as the shallow feature extraction module. However, convolutional layers of other sizes may be used for shallow feature extraction, and embodiments of the present disclosure are not limited to using a 3×3 convolutional layer for shallow feature extraction.
Deep Feature Extraction (432): This module comprises several residual Swin Transformer blocks (RSTBs). Each RSTB combines multiple Swin Transformer layers with a residual connection. The STLs capture long-range dependencies across antennas and subcarriers, while the residual connection is for stable training. In the example of FIG. 6, a single RSTB including 6 STLs is used as the deep feature extraction module. However, additional RSTBs may be used for deep feature extraction, and any number of STLs may be used within an RSTB. Embodiments of the present disclosure are not limited to using a single RSTB or RSTBs with 6 STLs for deep feature extraction.
High-Quality Image Reconstruction (433): This step reconstructs the high-quality image (i.e., the true channel response) using the extracted features. In the example of FIG. 6, a 3×3 convolutional layer is used as the high-quality image reconstruction module. However, convolutional layers of other sizes may be used for high-quality image reconstruction, and embodiments of the present disclosure are not limited to using a 3×3 convolutional layer for high-quality image reconstruction.

The hyper parameters for the Swin transformer-based CE model of FIG. 6 include the number of STLs in one RSTM, the number of RSTMs in deep feature extraction 432, and the network structure used for shallow feature extraction 431 and high-quality image reconstruction 433. In some embodiments, the hyper parameters may be obtained by experiments on the dataset generated at step 402. The hyper parameters can be tunable based on the size of the dataset, computation complexity constraints, memory constraints, etc. However, these hyperparameters are only illustrative, and do not restrict the various embodiments of the present disclosure.

Although FIG. 6 illustrates one example architecture 600 of a Swin transformer-based channel estimation model, various changes may be made to FIG. 6. For example, various changes to the number of STLs could be made, etc. according to particular needs.

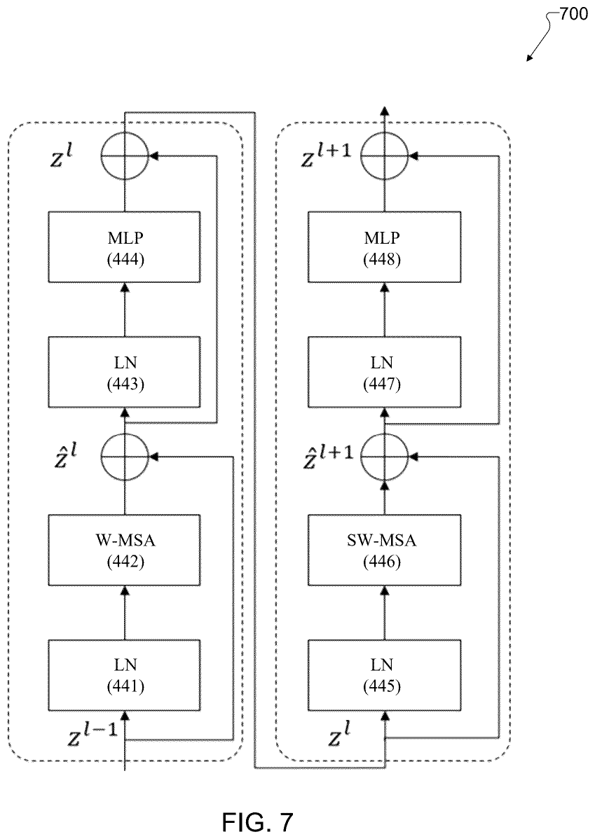

FIG. 7 illustrates an example STL structure 700 according to embodiments of the present disclosure. The embodiment of an STL structure of FIG. 7 is for illustration only. Different embodiments of an STL structure could be used without departing from the scope of this disclosure.

In the example of FIG. 7, a structure of two successive STLs is shown. For example, the two successive STLs of FIG. 7 may represent any two of the STLs shown in the RTSB for deep feature extraction 432 in FIG. 6.

STLs are the core of Swin transformer-based CE models as described herein. STLs are based on the standard multi-head self-attention (MSA) mechanism (steps 442 and 446 in FIG. 7) of the original transformer layer. The primary distinctions are the incorporation of the local attention and the shift-invariant mechanism. Assuming input of dimensions H×W×C, an STL as shown in FIG. 7 initially partitions the input image into non-overlapping local windows of shape M×M, reshaping the input image into a

$$\frac{HW}{{M}^{2}} \times {M}^{2} \times C feature . Here \frac{HW}{{M}^{2}}$$

is the number of local windows. Subsequently, the STL computes the standard self-attention independently within each window, referred to as local attention. For a local window feature X∈ [symbol] ^{M}^{²}^{×C}, the query, key and value matrices Q, K, and V are computed as

$$\{ \begin{matrix}Q = {XP}_{Q} , \\ K = {XP}_{K} , \\ V = {XP}_{V} ,\end{matrix} \qquad ( 3 )$$

where P_{Q}, P_{K} and P_{V} are projection matrices that are uniformly applied across different windows. Typically, Q, K, V∈ [symbol] ^{M}^{²}^{×d} are had. The attention matrix within a local window is then determined by the self-attention mechanism as

$$Attention ( Q , K , V ) = Softmax ( \frac{{QK}^{T}}{\sqrt{d}} + B ) , \qquad ( 4 )$$

where B is the learnable relative positional encoding. Since the relative position along each axis lies in the range [−M +1, M−1], a smaller-sized bias matrix \hat{B}∈ [symbol] ^{(2M-1)×(2M-1)} is used, and values in B are taken from B. Every element in B is a learnable scalar parameter which represents one type of relative positional relationship.

One of the advantages of the local window attention mechanism is the local window attention mechanism can enable efficient attention calculation. For example, for a feature with shape (h, w, C), where h and w are the height and width of the feature and C is the embedding dimension, the computational complexity of a global MSA module and a M×M window based MSA are

$$Ω ( MSA ) = 4 {hwC}^{2} + 2 {( hw )}^{2} C , \qquad ( 5 )$$

$$Ω ( W - MSA ) = 4 {hwC}^{2} + 2 {M}^{2} hwC . \qquad ( 6 )$$

The complexity of the global MSA is quadratic to the feature size hw, while the windowed complexity is linear when M is fixed. Global self-attention computation is generally unaffordable for a large hw. On the other hand, the window based self-attention is scalable. As long as an appropriate window size is found, the complexity of the windowed MSA can be much lower than the global MSA.

As shown in FIG. 7, first a LayerNorm (LN) layer is applied (steps 441 and 445) to the input data. Then, in steps 442 or 446, the attention function is performed for h times in parallel and the results are concatenated for multihead self-attention (MSA), where h is the number of attention heads. Then, a multi-layered perceptron (MLP), comprising two fully connected layers with Gaussian error linear unit (GELU) non-linearities in between, is used to transform features further in steps 444 and 448. Before both MSA and MLP, a LN layer (443 and 447) is applied, and residual connections are utilized for both components. However, the self-attention module using window lacks inter-window connections, limiting the self-attention module's ability to model the global dependency. For introducing connections across windows while retaining efficient computations in non-overlapping windows, a shifted window partitioning method is used that alternates between two configuration settings in successive Swin Transformer layers. For example, a shifted window partitioning is applied in the second STL, as shown in step 446 in FIG. 7.

Although FIG. 7 illustrates one example STL structure 700, various changes may be made to FIG. 7. For example, various changes to number of successive STLs could be made, etc. according to particular needs.

As described herein, shifted window partitioning means shifting the feature by a stride of

$$[ \frac{M}{2} , \frac{M}{2} ]$$

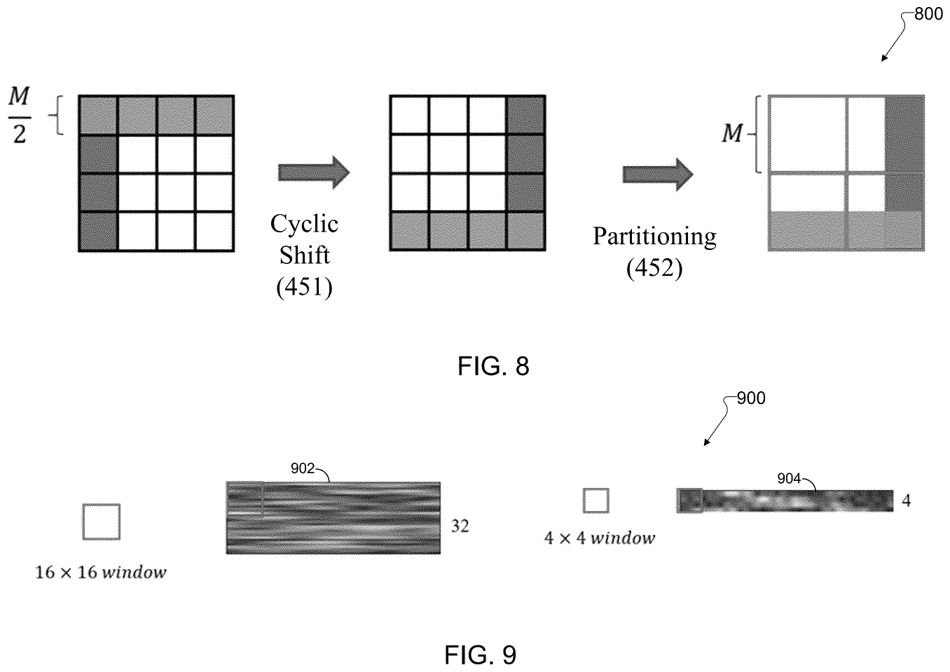

pixels before partitioning. In some embodiments, there are two steps of shifted window partitioning, as shown in FIG. 8.

FIG. 8 illustrates an example of shifted window partitioning 800 according to embodiments of the present disclosure. The embodiment of shifted window partitioning of FIG. 8 is for illustration only. Different embodiments of shifted window partitioning could be used without departing from the scope of this disclosure.

In the example of FIG. 8, the shifted window partitioning 800 begins at step 451. At step 451, a feature with a feature size 2M×2M, where M is the window size, is cyclically shifted by

$$\frac{M}{2} pixels [ \frac{M}{2} , \frac{M}{2} ]$$

to the right bottom. Then, in step 452, the cyclically shifted feature is partitioned to 4 non-overlapping windows with shape M×M. After MSA is performed (e.g., at step 446), the feature is shifted back using a

$$[ - \frac{M}{2} , - \frac{M}{2} ]$$

cyclic shift.

While the example of FIG. 8 uses a feature size 2M×2M, embodiments of the present disclosure are not limited to features of feature size 2M×2M, and the steps of shifted window partitioning 800 can be applied to other feature sizes.

Although FIG. 8 illustrates one example of shifted window partitioning 800, various changes may be made to FIG. 8. For example, various changes to window size could be made, etc. according to particular needs.

With the shifted window partitioning approach, the consecutive Swin Transformer blocks of FIG. 7 are blocks are computed as

$$\{ \begin{matrix}{\hat{z}}^{l} = W - MSA ( LN ( {z}^{l - 1} ) ) + {z}^{l - 1} \\ {z}^{l} = MLP ( LN ( {\hat{z}}^{l} ) ) + {\hat{z}}^{l} \\ {\hat{z}}^{l + 1} = SW - MSA ( LN ( {z}^{l} ) ) + {z}^{l} \\ {z}^{l + 1} = MLP ( LN ( {\hat{z}}^{l + 1} ) ) + {\hat{z}}^{l}\end{matrix} \qquad ( 7 )$$

At step 404, the trained Swin transformer-based CE model is applied to estimate a channel. For example, an SRS may be used as an input image for the trained Swin transformer-based CE model, and the trained Swin transformer-based CE model may output a channel estimation based on the input SRS.

In some embodiments, the trained Swin transformer-based CE model may be updated. For example, channel data such an SRS received during step 404 may be used to refine the trained Swin transformer-based CE model over time.

Although FIG. 4 illustrates one example procedure 400 for Swin transformer-based channel estimation, various changes may be made to FIG. 4. For example, while shown as a series of steps, various steps in FIG. 4 could overlap, occur in parallel, occur in a different order, occur any number of times, be omitted, or replaced by other steps.

To develop a Swin transformer-based CE model capable of functioning effectively across a range of SNR cases, the Swin transformer-based CE model should be trained using diverse training data encompassing various SNRs. However, employing a uniform loss function, such as the mean squared error (MSE), for samples with different SNRs often results in a skewed performance profile. In particular, the Swin transformer-based CE model may demonstrate a propensity for excelling at low SNR cases while simultaneously underperforming at high SNR cases. This phenomenon can be attributed to the fact that the losses incurred by low-SNR data samples are generally more substantial compared to those experienced by high SNR samples. As a consequence, during the training process, the Swin transformer-based CE model naturally gravitates towards focusing on learning from low-SNR cases, as doing so contributes significantly to the reduction of the overall loss function. This bias towards low-SNR cases ultimately hinders the Swin transformer-based CE model's ability to perform well across the entire spectrum of SNR conditions.

To overcome this issue, some embodiments may apply an SNR weighted MSE as the loss function as follows:

$${L}_{SNR weighted MSE} = \frac{L}{{w}_{SNR , 1}} δ ( SNR - {SNR}_{1} ) + \frac{L}{{w}_{SNR , 2}} δ ( SNR - {SNR}_{2} ) + … + \frac{L}{{w}_{SNR , N}} δ ( SNR - {SNR}_{N} ) , \qquad ( 8 )$$

where Loss L is the MSE loss, N is number of different SNRs in the training set and the weights

$${w}_{SNR , i} = {10}^{- \frac{{SNR}_{j}}{10}} . \qquad ( 9 )$$

In Swin transformer approaches, the input image is divided into non-overlapping windows. Self-attention is done among patches inside each window. As a result, the complexity of an STL increases quadratically with the window size. In the example of FIG. 8, the attention window is fixed as a square shape. In other words, each attention window can only include the same number of rows and columns of patches. In the context of channel estimation, the two dimensions of the channel matrix correspond to subcarriers and antennas, respectively. In many cases, the correlation across these two dimensions can be very different. Therefore, a square attention window may not be able to handle the dependency on the two dimensions efficiently. For example, in the frequency domain, a continuous forty subcarriers located within the coherent bandwidth have relatively strong correlation. To better catch the dependency and improve the performance of the CE, an attention window with size forty on the frequency dimension can be used. However, it is possible that the correlation on the antenna domain is relatively weak and a window size four is sufficient to catch the dependency on the antenna domain. In this case, using a square attention window with size forty on the antenna dimension wastes considerable computational resources without improving the performance. Furthermore, in cases with a small number of antennas, using a large attention window size becomes even impossible, as shown in the FIG. 9.

FIG. 9 illustrates an example limitation of square attention windows 900 according to embodiments of the present disclosure. The embodiment of a limitation of square attention windows of FIG. 9 is for illustration only. Different embodiments of a limitation of square attention windows could be used without departing from the scope of this disclosure.

In the example of FIG. 9, a 16×16 attention window is applied to a 80×32 input image 902, and a 4×4 attention window is applied to a 32×4 input image 904. In the example of input image 902, the window could be expanded to a 32×32 square window, but this may be inefficient, and the 32×32 window is unable to capture the entire first dimension of the input image. In the example of input image 904, the 4×4 attention window cannot be expanded while maintaining the square shape.

Although FIG. 9 illustrates one example limitation of square attention windows 900, various changes may be made to FIG. 9. For example, various changes to attention window sizes, the input window sizes, etc., could be made according to particular needs.

To overcome the limitations of a square attention window, a rectangular attention window may be applied to a Swin transformer-based CE model to catch the dependencies in the antenna and subcarrier dimensions more flexibly. A rectangular attention window can achieve a better balance of performance and model complexity. For example, in some embodiments a rectangular attention window with size [M, N] may be used, where M and N are different integers, resulting in a different attention window width for the frequency dimension and antenna dimension. In these embodiments, assuming input of dimensions H×W×C, an STL as shown in FIG. 7 initially partitions the input image into non-overlapping local windows of shape M×N, reshaping the input image into a

$$\frac{HW}{M \times N} \times M \times N \times C feature . Here \frac{HW}{M \times N}$$

is the number of local windows. Correspondingly, in the SW-MSA step (step 446 in FIG. 7) of the Swin transformer-based CE model, the stride of the cyclic shift will be

$$[ \frac{M}{2} , \frac{N}{2} ] .$$

A Swin transformer-based CE model using a rectangular attention window can catch long dependencies on the frequency domain even if the number of antennas in the channel is small.

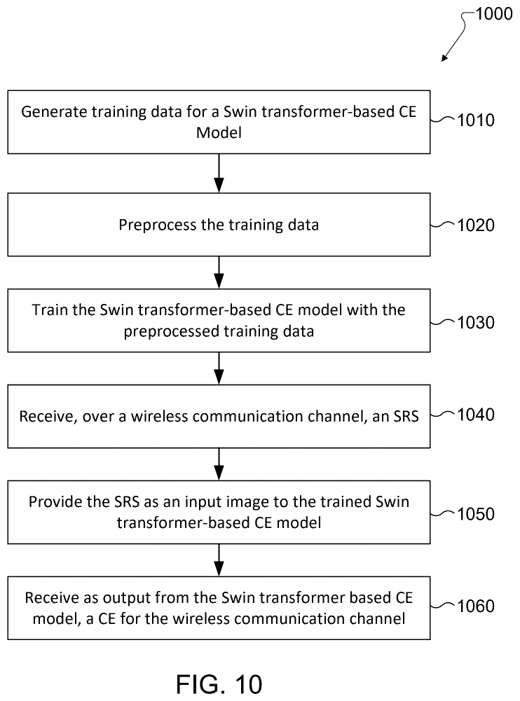

FIG. 10 illustrates an example method 1000 for Swin transformer-based wireless CE according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for Swin transformer-based wireless CE could be used without departing from the scope of this disclosure.

In the example of FIG. 10, method 1000 begins at step 1010. At step 1010, a BS (such as gNB 102 of FIG. 1) generates training data for a Swin transformer-based CE model. For example, the BS may generate the training data for the Swin transformer-based CE model similar as described regarding step 401 of FIG. 4. In some embodiments, to generate at least some of the training data, the BS may store a plurality of SRSs received by the BS over a period of time. For example, the SRSs may be received by one or more of UEs 111-116 of FIG. 1. In some embodiments, to generate at least some of the training data, the BS may perform a channel simulation based on at least one wireless channel model.

In some embodiments, the Swin transformer-based CE model may include (i) a shallow feature extraction module (such as shallow feature extraction 431 of FIG. 6), (ii) a deep feature extraction module comprising at least one residual Swin transformer block (RSTB) that includes a plurality of Swin transformer layers (STLs) (such as deep feature extraction 432 of FIG. 6), and (iii) a high-quality image construction module configured to reconstruct a high quality image from features extracted by the shallow feature extraction module and the deep feature extraction module (such as high quality image reconstruction 432 of FIG. 6). In some embodiments, each STL of the plurality of STLs may include (i) a first layer norm (LN) layer (such as LN 441 or LN 445 of FIG. 7), (ii) an attention function (such as W-MSA 442 or SW-MSA 446 of FIG. 7), (iii) a second LN layer (such as LN 443 or LN 447 of FIG. 7), and (iv) a multi-layered perceptron function (such as MLP 444 or MLP 448 of FIG. 7). In some embodiments, successive STLs of the plurality of STLs may alternate between two configuration settings to apply shifted window partitioning in every other STL of the plurality of STLs (such as STL structure 700 of FIG. 7).

At step 1020, the BS preprocesses the training data. For example, the BS may preprocess the training data similar as described regarding step 402 of FIG. 4 In some embodiments, to preprocess the training data, the BS may transform the training data, with an inverse fast Fourier transform (IFTT), from a frequency domain to a delay domain (such as in step 421 of FIG. 5), and transform the transformed training data, with a 2-dimensional fast Fourier transform (2D FFT), from the delay domain to an angular domain (such as in step 422 of FIG. 5).

At step 1030, the BS trains the Swin transformer-based CE model with the preprocessed training data. For example, the BS may train the Swin transformer-based CE model with the preprocessed training data similar as described regarding step 403 of FIG. 4.

At step 1040, the BS receives, over a wireless communication channel, an SRS. For example, the BS may receive an SRS from one of UEs 111-116 of FIG. 1.

At step 1050, the BS provides the SRS as an input image to the trained Swin transformer-based CE model. Input image is used by the trained Swin transformer-based CE model to estimate the channel. For example, the trained Swin transformer-based CE model may estimate the channel similar as described regarding step 404 of FIG. 4.

At step 1060, the BS receives as output from the trained Swin transformer-based CE model, a CE for the wireless communication channel.

In some embodiments, the BS may update the Swin transformer-based CE model based on the SRS received over the wireless communication channel.

In some embodiments, the Swin transformer-based CE model may be configured to perform CEs based on a rectangular attention window of size [M, N], where M and N are different integers, M corresponds with subcarrier features, and N corresponds with antenna features.

Although FIG. 10 illustrates one example method 1000 for Swin transformer-based wireless CE, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a processor configured to:
generate training data for a shifted window (Swin) transformer-based channel estimation (CE) model;
preprocess the training data; and
train the Swin transformer-based CE model with the preprocessed training data; and
a transceiver operatively coupled to the processor, the transceiver configured to receive, over a wireless communication channel, a sounding reference signal (SRS),
wherein the processor is further configured to:
provide the SRS as an input image to the trained Swin transformer-based CE model; and
receive as output from the trained Swin transformer-based CE model, a CE for the wireless communication channel.

2. The BS of claim 1, wherein the processor is further configured to update the Swin transformer-based CE model based on the SRS received over the wireless communication channel.

3. The BS of claim 1, wherein to generate the training data, the processor is further configured to at least one of:
store a plurality of SRSs received by the transceiver over a period of time; and
perform a channel simulation based on at least one wireless channel model.

4. The BS of claim 1, wherein to preprocess the training data, the processor is further configured to:
transform the training data, with an inverse fast Fourier transform (IFTT), from a frequency domain to a delay domain; and
transform the transformed training data, with a 2-dimensional fast Fourier transform (2D FFT), from the delay domain to an angular domain.

5. The BS of claim 1, wherein the Swin transformer-based CE model comprises:
a shallow feature extraction module;
a deep feature extraction module comprising at least one residual Swin transformer block (RSTB) that includes a plurality of Swin transformer layers (STLs); and
a high-quality image construction module configured to reconstruct a high quality image from features extracted by the shallow feature extraction module and the deep feature extraction module.

6. The BS of claim 5, wherein each STL of the plurality of STLs includes:
a first layer norm (LN) layer;
an attention function;
a second LN layer; and
a multi-layered perceptron function.

7. The BS of claim 5, wherein successive STLs of the plurality of STLs alternate between two configuration settings to apply shifted window partitioning in every other STL of the plurality of STLs.

8. The BS of claim 1, wherein the Swin transformer-based CE model is configured to perform CEs based on a rectangular attention window of size [M, N], where M and N are different integers, M corresponds with subcarrier features, and N corresponds with antenna features.

9. A method of operating a base station (BS), the method comprising:
generating training data for a shifted window (Swin) transformer-based channel estimation (CE) model;
preprocessing the training data;
training the Swin transformer-based CE model with the preprocessed training data;
receiving, over a wireless communication channel, a sounding reference signal (SRS);
providing the SRS as an input image to the trained Swin transformer-based CE model; and
receiving as output from the trained Swin transformer-based CE model, a CE for the wireless communication channel.

10. The method of claim 9, further comprising updating the Swin transformer-based CE model based on the SRS received over the wireless communication channel.

11. The method of claim 9, wherein to generate the training data, the method further comprises:
storing a plurality of SRSs received by the BS over a period of time; and
performing a channel simulation based on at least one wireless channel model.

12. The method of claim 9, wherein to preprocess the training data, the method further comprises:
transforming the training data, with an inverse fast Fourier transform (IFTT), from a frequency domain to a delay domain; and
transform the transformed training data, with a 2-dimensional fast Fourier transform (2D FFT), from the delay domain to an angular domain.

13. The method of claim 9, wherein the Swin transformer-based CE model comprises:
a shallow feature extraction module;
a deep feature extraction module comprising at least one residual Swin transformer block (RSTB) that includes a plurality of Swin transformer layers (STLs); and
a high-quality image construction module configured to reconstruct a high quality image from features extracted by the shallow feature extraction module and the deep feature extraction module.

14. The method of claim 13, wherein each STL of the plurality of STLs includes:
a first layer norm (LN) layer;
an attention function;
a second LN layer; and
a multi-layered perceptron function.

15. The method of claim 13, wherein successive STLs of the plurality of STLs alternate between two configuration settings to apply shifted window partitioning in every other STL of the plurality of STLs.

16. The method of claim 9, wherein the Swin transformer-based CE model is configured to perform CEs based on a rectangular attention window of size [M, N], where M and N are different integers, M corresponds with subcarrier features, and N corresponds with antenna features.

17. A non-transitory computer readable medium embodying a computer program comprising program code that, when executed by a processor of a device, causes the device to:
generate training data for a shifted window (Swin) transformer-based channel estimation (CE) model;
preprocess the training data;
train the Swin transformer-based CE model with the preprocessed training data;
receive, over a wireless communication channel, a sounding reference signal (SRS);
provide the SRS as an input image to the trained Swin transformer-based CE model; and
receive as output from the trained Swin transformer-based CE model, a CE for the wireless communication channel.

18. The non-transitory computer readable medium of claim 17, wherein the Swin transformer-based CE model comprises:
a shallow feature extraction module;
a deep feature extraction module comprising at least one residual Swin transformer block (RSTB) that includes a plurality of Swin transformer layers (STLs); and
a high-quality image construction module configured to reconstruct a high quality image from features extracted by the shallow feature extraction module and the deep feature extraction module.

19. The non-transitory computer readable medium of claim 18, wherein successive STLs of the plurality of STLs alternate between two configuration settings to apply shifted window partitioning in every other STL of the plurality of STLs.

20. The non-transitory computer readable medium of claim 17, wherein the Swin transformer-based CE model is configured to perform CEs based on a rectangular attention window of size [M, N], where M and N are different integers, M corresponds with subcarrier features, and N corresponds with antenna features.
